(19) United States
(12) Patent Application Publication
(10) Pub. No.: US 2026/0097584 A1
(43) Pub. Date: Apr. 9, 2026

(54) LIQUID EJECTION HEAD AND METHOD FOR PRODUCING LIQUID EJECTION HEAD

(71) Applicant: CANON KABUSHIKI KAISHA, Tokyo (JP)

(72) Inventors: HARUKA YAMAJI, Tokyo (JP); SATOSHI TSUTSUI, Kanagawa (JP); ERIKA KOBATAKE, Kanagawa (JP); YOHEI HAMADE, Tokyo (JP)

(21) Appl. No.: 19/341,352

(22) Filed: Sep. 26, 2025

(30) Foreign Application Priority Data
Oct. 3, 2024 (JP) 2024-174442

(51) Int. Cl. B41J 2/16; C08G 77/24; C09D 183/08

(52) U.S. Cl. CPC B41J 2/1606; C08G 77/24; C09D 183/08

(57) ABSTRACT

Provided is a liquid ejection head having a cured product of a liquid-repellent coating material, the coating material including a condensation product of a silane mixture containing a hydrolyzable silane compound (a) of a specific structure having a perfluoropolyether group and a cyclic polyorganosiloxane group and a hydrolyzable silane compound (b) having an epoxy group.

### BACKGROUND

### Field of the Technology

The present disclosure relates to a liquid ejection head and a method for producing a liquid ejection head.

### Description of the Related Art

In various fields, methods for achieving water resistance and ink repellency by applying a water-repellent coating material to the surface of a member that requires these properties have been generally known, and resin materials and coating materials suitable for this purpose have been developed. For example, fluorine-containing coating materials that contain fluoroolefins or have perfluoro groups are extremely stable both thermally and chemically, and exhibit excellent weather resistance, water resistance, chemical resistance, and solvent resistance and also exhibit excellent mold releasability, friction resistance, and water repellency, and are widely used in various applications.

To mention one specific example, in an inkjet liquid ejection head that ejects ink as small droplets from the ejection port to adhere to paper sheets or other media for recording or image formation, it is desirable for the ejection port to exhibit the following performances: (1) the remaining ink of the ink column in the form of droplets is quickly re-stored in the nozzle; (2) ink droplets adhered to the surface are easily swept out by cleaning operations; (3) ink droplets adhered to the surface show excellent scratch resistance in cleaning operations and paper transportation; (4) in repeated droplet formation and ink refilling, a meniscus is formed at the nozzle surface position; (5) the normal direction of the meniscus matches the ejecting direction; and (6) even with an ink with low surface tension or in a low negative pressure state, the ink has an interfacial tension, that is, contact angle, enough to allow the ejection port to form a meniscus.

The reason why these performances are required for the ejection port is that these performances directly relate to the printing performance. If a recording liquid, such as ink, adheres around the ejection port, there may occur a deviation in the ejection (flying) direction of the liquid droplets, and printing with high accuracy may not be performed. In order to prevent the liquid from adhering to the vicinity of the ejection port, which causes such a deviation in the discharge direction, a method for performing a water-repellent treatment on the surface where the ejection port is formed is known.

For example, Japanese Patent Application Laid-open No. 2014-205739 discloses a liquid-repellent layer made of a fluorine-containing coating material that contains a condensation product of a hydrolyzable silane compound.

Incidentally, the requirements for liquid repellency of the liquid-repellent layer, as described above, have become increasingly high as the performance of recent inkjet printers has been rapidly improved. Specifically, the type of solvent and the amount of solvent contained in the inkjet inks have increased, and a liquid-repellent layer having resistance to such inks has been desired. Furthermore, the inkjet head needs to remove ink from the head surface by wiping, and as the service life of the inkjet head is longer, a liquid-repellent layer with better scratch resistance than before has been required. It is not easy to develop such ink resistance and scratch resistance. The liquid-repellent layer described in Japanese Patent Application Laid-open No. 2014-205739 may be insufficient in terms of the performance required for recent inkjet heads.

### SUMMARY

The present disclosure directs to a liquid ejection head exhibiting excellent ink resistance and scratch resistance, and a method for producing a liquid ejection head.

The present disclosure relates to a liquid ejection head comprising a cured product of a liquid-repellent coating material, the coating material comprising: a condensation product of a silane mixture comprising a hydrolyzable silane compound (a) having a perfluoropolyether group and a cyclic polyorganosiloxane group and represented by formula (1) below and a hydrolyzable silane compound (b) having an epoxy group.

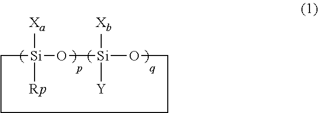

In the formula (1), p is an integer of 1 or more, q is an integer of 1 or more, p+q is 4 or more, and an arrangement of a structure of a parenthesis with p and a structure of a parenthesis with q may be block or random; Xas represent alkyl groups; Xbs represent alkyl groups; Rps are perfluoropolyether groups represented by formula (2) below; Ys are structures having hydrolyzable silyl groups represented by formula (3) below.

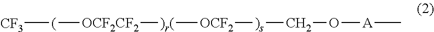

In the formula (2), r is 20 to 30, and s is 20 to 30; an arrangement of a structure of a parenthesis with r and a structure of a parenthesis with s may be block or random; and A represents an organic group.

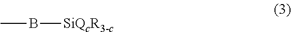

In the formula (3), c is an integer of 3 or less, B is a C1-12 organic group, Qs are hydrolyzable substituents, and R₅ are non-hydrolyzable substituents.

Features of the present disclosure will become apparent from the following description of embodiments with reference to the attached drawings. The following description of embodiments is described by way of examples.

### BRIEF DESCRIPTION OF THE DRAWINGS

FIG. 1 is a perspective view of the main part of a configuration example of a liquid ejection head.

FIG. 2 is a cross-sectional view of the liquid ejection head.

FIGS. 3A to 3E are views illustrating a method for producing a liquid ejection head.

FIGS. 4A to 4F are views illustrating a method for producing a liquid ejection head.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple XXs may be selected from the group, and the same applies to YY and ZZ.

### Liquid-Repellent Coating Material

A liquid ejection head according to the present disclosure has a cured product of a coating material with liquid-repellency, such as water repellency. The liquid-repellent coating material contains a condensation product of a silane mixture containing a hydrolyzable silane compound. The hydrolyzable silane compound contains a hydrolyzable silane compound (a) having a perfluoropolyether group and a cyclic polyorganosiloxane group and represented by formula (1) and a hydrolyzable silane compound (b) having an epoxy group.

In the liquid-repellent coating material, the liquid-repellent and anti-fouling functions are expressed by a hydrolyzable silane compound (a) having a perfluoropolyether group and a cyclic polyorganosiloxane group and represented by formula (1). The hydrolyzable silane compound (a) having a long-chain polyfluoropolyether group represented by formula (2) makes sliding properties better and greatly improves wiping durability. Furthermore, the cyclic polyorganosiloxane group has an effect of suppressing the aggregation of fluorine components and orienting fluorine groups on the surface. In addition, combining the hydrolyzable silane compound (b) having an epoxy group with the hydrolyzable silane compound (a) can enhance the durability of a coating film. Hereinafter, the present disclosure will be described in more detail.

### Component (a): Hydrolyzable Silane Compound (a) Having Perfluoropolyether Group and Cyclic Polyorganosiloxane Group and Represented by Formula (1)

The coating material has a hydrolyzable silane compound (a) having a perfluoropolyether group and a cyclic polyorganosiloxane group and represented by the following formula (1).

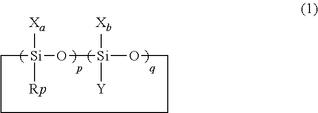

In the formula (1), p is an integer of 1 or more, and, for example, 1 to 5, preferably 1 to 3, and more preferably 1 or 2. q is an integer of 1 or more, and, for example, 1 to 5, preferably 1 to 3, and more preferably 2 or 3. p+q is an integer of 4 or more, and, for example, 4 to 10, preferably 4 to 8, and more preferably 4 to 6. From the viewpoint of smoothing the surface when a coating film of the coating material is formed and suppressing development residues, p+q is particularly preferably 4. Furthermore, from the viewpoint of further improving liquid repellency and scratch resistance, it is still more preferable that p is 1 or 2 and q is 2 or 3, and it is particularly preferably that p is 1 and q is 3. An arrangement of a structure of a parenthesis with p and a structure of a parenthesis with q may be block or random.

Xas represent alkyl groups, and, for example, C1-3 (preferably C1 or C2, more preferably C1) alkyl groups.

Xbs represent alkyl groups, and, for example, C1-3 (preferably C1 or C2, more preferably C1) alkyl groups.

Rps are perfluoropolyether groups represented by the formula (2) below.

Ys are hydrolyzable silyl groups represented by the formula (3) below.

A perfluoropolyether group is a group in which one or more structures including a perfluoroalkyl group and an oxygen atom (ether bond) are connected. Specifically, the perfluoropolyether group is a group represented by the following formula (2). The perfluoropolyether group can provide liquid repellency and sliding properties.

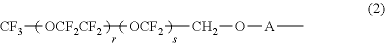

In the formula (2), r is 20 to 30, preferably 23 to 30, more preferably 25 to 30, or may be 23 to 27. s is 20 to 30, preferably 23 to 30, more preferably 25 to 30, or may be 23 to 27. r and s are, for example, integers. The arrangement of the structure of the parenthesis with r and the structure of the parenthesis with s may be a block or random. It is particularly preferable that r=s=25.

A represents an organic group, preferably a C1-6 (more preferably C2-4) alkylene group. A is more preferably —C₃H₆—. That is, the group represented by the formula (2) is preferably represented by the formula (5) below.

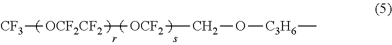

In addition, the cyclic polyorganosiloxane group is a group in which Si atoms and oxygen atoms are alternately bound to form a ring. Specifically, the cyclic polyorganosiloxane group has a cyclic structure included in the formula (1). The cyclic polyorganosiloxane group exhibits liquid repellency and effects of suppressing the aggregation of fluorine components.

As described above, in formula (1), Y is a hydrolyzable silyl group represented by the formula (3) below.

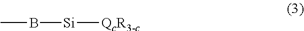

In the formula (3), c is an integer of 3 or less, preferably 2 or 3, and more preferably 3.

B is a C1-12 organic group, and, for example, a C1-12 (preferably C1-10) alkylene group. From the viewpoint of smoothing the surface when the coating film of the coating material is formed and suppressing development residues, B is more preferably a C4-10 alkylene group. From the viewpoint of further improving liquid repellency and scratch resistance, B is still more preferably a C6-9 alkylene group, and even more preferably a C8 alkylene group.

Qs are hydrolyzable substituents, and, for example, each independently a halogen atom, an alkoxy group, a hydroxy group, an amino group, or a hydrogen atom. The number of carbon atoms in the alkoxy group is, for example, 1 to 6, preferably 1 to 3, more preferably 1 or 2, and still more preferably 1. Qs are preferably alkoxy groups.

Rs are non-hydrolyzable substituents, and, for example, each independently a C1-3 alkyl group, such as a methyl group or an ethyl group, a phenyl group, or the like.

Y is preferably a structure represented by the formula (6) below.

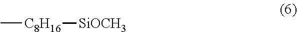

A compound represented by the formula (I) below is particularly preferred as the hydrolyzable silane compound (a) from the viewpoint of liquid repellency, sliding properties, and fluorine aggregation inhibition.

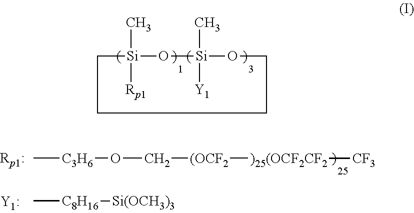

The structure of the hydrolyzable silane compound (a) can be analyzed using nuclear magnetic resonance (hereinafter referred to as NMR) spectroscopy. Specifically, combinations of ¹H-, ¹³C-, ¹⁹F-, and ²⁹Si-NMR enables structural analysis.

### Hydrolyzable Silane Compound (b) Having Epoxy Group

The hydrolyzable silane compound (b) having an epoxy group is not particularly limited, but a compound represented by the formula (9) below is preferred.

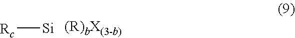

In the formula (9), Rc is a non-hydrolyzable substituent having an epoxy group, and, for example, represented by -E-Z. Z is an epoxy group, a glycidyl group, a glycidoxy group, or an epoxycycloalkyl group (preferably a glycidoxy group or an epoxycyclohexyl group), and E is a C1-8 (preferably C2-8) alkylene group. Rs are non-hydrolyzable substituents, and, for example, each independently a C1-3 alkyl group, such as a methyl group or an ethyl group, a phenyl group, or the like. X is a hydrolyzable substituent. b is an integer from 0 to 2. b is preferably 0 or 1, and more preferably 0.

In the formula (9), Rc is preferably a glycidoxypropyl group, an epoxycyclohexylethyl group, and the like, and more preferably a glycidoxypropyl group. Examples of Rs may include alkyl groups, such as methyl groups and ethyl groups, phenyl groups, and the like.

Examples of Xs may include halogen atoms, alkoxy groups, hydroxy groups, amino groups, hydrogen atoms, and the like. The number of carbon atoms in the alkoxy group is, for example, 1 to 6, preferably 1 to 3, more preferably 1 or 2, and still more preferably 1.

Among these, from the viewpoint that the group released by the hydrolysis reaction does not inhibit the cationic polymerization reaction and is easy to control the reactivity, Xs are preferably alkoxy groups, such as methoxy groups, ethoxy groups, and propoxy groups. Alternatively, Xs may be partially hydrolyzed to form hydroxy groups, or dehydrated and condensed to form siloxane bonds.

Specific examples of the compound represented by formula (9), wherein X is an alkoxy group, may include at least one selected from the group consisting of glycidoxypropyltrimethoxysilane, glycidoxypropyltriethoxysilane, epoxycyclohexylethyltrimethoxysilane, epoxycyclohexylethyltriethoxysilane, glycidoxypropylmethyldimethoxysilane, glycidoxypropylmethyldiethoxysilane, glycidoxypropyldimethylmethoxysilane, glycidoxypropyldimethylethoxysilane, and the like. These compounds may be used alone, or two or more thereof may be used in combination.

Still more preferable specific examples of the hydrolyzable silane compound (b) having an epoxy group may include at least one selected from the group consisting of a compound represented by formula (7) and a compound represented by formula (8) from the viewpoint of reactivity with the photopolymerizable resin layer used as a foundation.

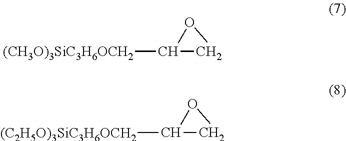

The structure of the hydrolyzable silane compound (b) having an epoxy group is analyzable by nuclear magnetic resonance (hereinafter referred to as NMR) spectroscopy. Specifically, structural analysis is possible by combining ¹H-, ¹³C-, and ²⁹Si-NMR.

### Component (c): Other Hydrolyzable Silane Compounds

The silane mixture in the coating material may contain a hydrolyzable silane compound (c) that is another hydrolyzable silane compound different from the component (a) and the component (b). The hydrolyzable silane compound (c) is not particularly limited, but is preferably a hydrolyzable silane compound represented by the following formula (10) having a fluorine-containing group other than a perfluoropolyether group from the viewpoint of fluorine surface orientation.

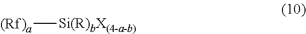

In the formula (10), Rf has at least one fluorine atom. That is, Rf is a (preferably C1-10, more preferably C2-8, still more preferably C3-8) alkyl group or a (preferably C6-10, more preferably C6) aryl group in which at least one hydrogen atom is replaced with a fluorine atom. Rs are non-hydrolyzable substituents, and Xs are hydrolyzable substituents. a is an integer or 1 or 2, and preferably 1. b is an integer from 0 to 2, and preferably 0. a+b is an integer of 1 to 3.

In the formula (10), Rfs are preferably alkyl or aryl groups in which 1 to 15 hydrogen atoms are replaced with fluorine atoms, and more preferably alkyl or aryl groups in which 3 to 10 (still more preferably 3 to 5) hydrogen atoms are replaced with fluorine atoms. When Rfs are alkyl groups, 40% to 80% hydrogen atoms from the terminal side of the alkyl chain are preferably replaced with fluorine atoms. If Rfs are aryl groups (more preferably phenyl groups), it is preferred that all hydrogen atoms are replaced with fluorine atoms.

Rfs containing fluorine atoms prevent the separation of perfluoropolyether groups from other components and prevent the aggregation of perfluoropolyether groups Specific examples of Rfs may include methyl groups, ethyl groups, n-propyl group, isopropyl groups, n-butyl groups, sec-butyl groups, isobutyl groups, tert-butyl groups, phenyl groups, naphthyl groups, and the like, wherein part or all of hydrogen atoms are replaced with fluorine atoms.

Examples of Rs in the formula (10) may include alkyl groups, such as methyl groups, ethyl groups, and propyl groups, aryl groups, such as phenyl groups, and the like. Examples of Xs may include halogen atoms, alkoxy groups, such as methoxy groups, ethoxy groups, and propoxy groups, and the like.

Specific preferred examples of the components (c) may include the following compounds (C10) to (C17) that are readily available: 3,3,3-trifluoropropyltrimethoxysilane (C10); trimethoxy (1H,1H,2H,2H-nonafluorohexyl) silane (C11); trimethoxy-1H,1H,2H,2H-tridecafluoro-n-octylsilane (C12); trimethoxy (pentafluorophenyl) silane (C13); 3,3,3-trifluoropropyltriethoxysilane (C14); triethoxy (1H,1H,2H,2H-nonafluorohexyl) silane (C15); triethoxy-1H,1H,2H,2H-tridecafluoro-n-octylsilane (C16); and triethoxy (pentafluorophenyl) silane (C17).

These compounds may be used alone, or two or more thereof may be used in combination.

In the hydrolyzable silane compound contained in the silane mixture, the content ratio of the hydrolyzable silane compound (a) having a perfluoropolyether group and a cyclic polyorganosiloxane group is, for example, 0.005 to 1.0 mol %, preferably 0.01 to 0.80 mol %, more preferably 0.03 to 0.50 mol %, and still more preferably 0.04 to 0.20 mol %.

When the component (a) is contained in an amount of 0.01 mol % or more, more sufficient liquid repellency can be exhibited. When the content of the component (a) is 0.80 mol % or less, aggregation of fluorine atoms can be prevented more sufficiently, and the occurrence of unevenness and development residues on the surface of the liquid-repellent coating can be better suppressed.

In the hydrolyzable silane compounds contained in the silane mixture, the content ratio of the hydrolyzable silane compound (b) having an epoxy group is, for example, 40.0 to 99.995 mol %, and preferably 45.0 to 99.90 mol %.

The hydrolyzable silane compound contained in the silane mixture may contain, for example, 0.00 to 50.00 mol %, preferably 20.00 to 60.00 mol % of the hydrolyzable silane compound (c).

In the hydrolyzable silane compound contained in the silane mixture, the content ratio of the hydrolyzable silane compound (a) having a perfluoropolyether group and a cyclic polyorganosiloxane group is, for example, 0.2% to 10.0% by mass, preferably 0.5% to 9.0% by mass, and more preferably 0.7% to 3.0% by mass.

In the hydrolyzable silane compound contained in the silane mixture, the content ratio of the hydrolyzable silane compound (b) having an epoxy group is, for example, 20.0% to 99.8% by mass, and preferably 25.0% to 99.5% by mass.

In the coating material of the present disclosure, each hydrolyzable silane compound is not used alone, but is used as a condensation product of a silane mixture containing a hydrolyzable silane compound. Thus, the film-forming property at the time of application becomes better, and a smooth coating film is stably obtained. Furthermore, when the coating material can be applied to a photopolymerizable resin layer and cured collectively with the photopolymerizable resin layer, durability can be improved, and the condensation product can control the compatibility with the resin layer and the patterning characteristics.

The condensation reaction of the hydrolyzable silane compound can be carried out by heating in a solvent in the presence of water to progress the hydrolysis and condensation reaction. The desired degree of condensation can be achieved by appropriately controlling the hydrolysis and condensation reactions through temperature, time, concentration, pH, and the like. The conditions are not particularly limited because the conditions differ depending on the hydrolyzable silane compound used, and suitable conditions for the hydrolyzable silane compound used may be selected.

Also, metal alkoxides, acids, alkalis, and the like can be utilized as catalysts in the hydrolysis and condensation reactions. Examples of metal alkoxides may include aluminum alkoxides, titanium alkoxides, zirconia alkoxides, and media thereof (such as acetylacetone complexes). These metal alkoxides may be used alone, or two or more thereof may be used in combination.

It is also useful to adjust the pH using acids or alkalis. However, when an alkali catalyst is used, an acid catalyst is preferred because solids, such as gel, may precipitate in a solution. That is, the silane mixture preferably contains an acid catalyst. Specific examples may include carboxylic acids, such as acetic acid, glycolic acid, and formic acid. These may be used alone, or two or more thereof may be used in combination. These organic acids are added during the reaction. Alternatively, an acid may be added separately because organic acids are often present in trace amounts in the raw material hydrolyzable silane compound.

In the present disclosure, a plurality of hydrolyzable silane compounds are used in combination. Thus, if the rates of hydrolysis and condensation reactions differ significantly depending on the type of hydrolyzable silane compounds, a compound having a high reaction rate will undergo a condensation reaction, and a compound having a slow reaction rate may remain unreacted. Therefore, from the viewpoint of reacting respective hydrolyzable silane compounds as uniformly as possible, it is preferable to use a catalyst, such as an acid.

The condensation product can be synthesized in a solvent having a hydroxyl group, a carbonyl group, an ether bond, and the like. That is, the silane mixture may contain a solvent. Specific examples of solvents may include alcohols, such as methanol, ethanol, propanol, isopropanol, and butanol; ketones, such as methyl ethyl ketone and methyl isobutyl ketone; esters, such as ethyl acetate and butyl acetate; ethers, such as propylene glycol monomethyl ether, diglyme, and tetrahydrofuran; non-fluorine organic solvents, such as glycols like diethylene glycol. These may be used alone, or two or more thereof may be used in combination. In addition, since water is used for synthesis, alcohols with high solubility in water are preferred. Therefore, when the reaction is performed by heating to reflux, it is preferable to use an organic solvent having a boiling point of 50° C. to 100° C.

The amount of water used for the reaction is preferably 0.5 to 3 equivalents, and more preferably 0.8 to 2 equivalents, relative to the hydrolyzable substituent of the hydrolyzable silane compound. An amount of water of 0.5 equivalents or more can provide a sufficient reaction rate in hydrolysis and condensation reactions. An amount of water of 3 equivalents or less can suppress the precipitation of the hydrolyzable silane compound having a perfluoropolyether group.

### Liquid-Repellent Coating

The liquid ejection head includes liquid-repellent coating. The liquid-repellent coating is a cured product of a liquid-repellent coating material. The liquid-repellent coating, for example, is a cured product of a condensation product contained in a coating material. The liquid-repellent coating is obtained, for example, by using a liquid-repellent coating material and curing the condensation product contained in the liquid-repellent coating material with a photopolymerization initiator. That is, the liquid-repellent coating may be a cured product of a coating material containing the condensation product and the photopolymerization initiator.

A photopolymerization initiator is preferably used to cure the condensation product having an epoxy group and a silanol group by irradiation with light. As the photo-polymerization initiator, a photoacid-generating agent, such as an onium salt compound, including a sulfonium salt or an iodonium salt, a sulfonic acid compound, a diazomethane compound, and the like may be used.

Examples of commercially available products may include “ADEKA Optomer SP-170”, “ADEKA Optomer SP-172”, and “SP-150” (trade name) manufactured by ADEKA Corporation; “BBI-103” and “BBI-102” (trade name) manufactured by Midori Kagaku Co., Ltd.; “IBPF”, “IBCF”, “TS-01”, and “TS-91” (trade name) manufactured by Sanwa Chemical Co., Ltd., and the like. These photo-polymerization initiators may be used alone, or two or more thereof may be used in combination.

A photoacid-generating agent is preferable because when it is used as a photo-polymerization initiator, the dehydration condensation reaction of not only epoxy groups but also silanol groups is promoted by acids. In order to improve the patterning characteristics, a light-absorbing agent, a sensitizing agent, or the like may be used. By adding these photo-polymerization initiators to a liquid-repellent coating material, a coating solution for liquid repellent coatings can be adjusted.

When the foundation (for example, a photopolymerizable resin composition) of the coating liquid for liquid-repellent coating contains a photoacid-generating agent, acids migrate from the foundation to the coating material and diffuse, allowing the coating film to be cured without the need to add a photoacid-generating agent to the liquid-repellent coating material.

The coating film of the coating liquid for liquid-repellent coating can be formed by applying a coating liquid prepared by dissolving, for example, a liquid-repellent coating material and a photopolymerization initiator in a solvent, as appropriate, using a coater. As the coater, general-purpose apparatuses, such as a spin coater, a die coater, a slit coater, and a spray coater, may be used. Also, a dip coating can be applied by adjusting the concentration of the liquid-repellent coating material.

The concentration of the condensation product in the coating liquid is determined, as appropriate, depending on the composition of the condensation product, the coating method, and the use. However, the concentration of the condensation product in the coating liquid is preferably 0.1% to 20% by mass and more preferably 1% to 15% by mass. If the concentration of the condensation product is within the above range, sufficient liquid repellency and durability can be achieved, and uniform liquid repellency can be obtained over the entire surface of the coating film.

The thickness of the coating film is preferably 50 to 10000 nm, and more preferably 80 to 5000 nm. A film thickness of 50 nm or more can achieve uniform liquid repellency and sufficient durability. In contrast, a film thickness of 10000 nm or less can suppress the degradation of patterning characteristics, such as pattern deformation and resolution loss.

After a coating film is formed on the substrate by any method, the coating film is irradiated with light and cured by light or heat as required to cure the coating film. High durability can be achieved even in a thin film by using both cationic polymerization of an epoxy group and condensation polymerization of a silane (a silanol group) via heat in combination with the curing reaction of the coating film.

Furthermore, pattern exposure at the time of light irradiation can treat the surface of fine regions by a liquid-repellent coating. When pattern exposure is performed, curing can be performed by stronger light irradiation or heating after development. The durability can be enhanced by performing an appropriate curing treatment to completely cure unreacted groups.

The coating material may further contain an epoxy compound other than the hydrolyzable silane compound (b) having an epoxy group. That is, the liquid-repellent coating may be a cured product of a coating material containing a coating material, an epoxy compound other than the hydrolyzable silane compound (b), and a photopolymerization initiator. Containing the epoxy compound can increase the viscosity of the coating liquid and the film thickness.

Examples of epoxy compounds other than the hydrolyzable silane compounds may include a bisphenol A-type epoxy resin, a novolac-type epoxy resin, and the like. Examples of commercially available products may include “CELLOXIDE 2021”, “GT-300 series”, “GT-400 series”, and “EHPE 3150” (trade name) manufactured by Daicel Corporation; “157S70” (trade name) manufactured by Japan Epoxy Resin Co., Ltd.; “EPICLON N-695” (trade name) manufactured by Dainippon Ink and Chemicals, Inc.; and “SU-8” (trade name) manufactured by Nippon Kayaku Co., Ltd.; and the like. These may be used alone, or two or more thereof may be used in combination.

The epoxy equivalent of the epoxy compound other than the hydrolyzable silane compound (b) is preferably 2000 or less, and more preferably 1000 or less. The epoxy equivalent of 2000 or less provides a sufficient cross-linking density during the curing reaction, does not lower the glass transition temperature of the cured product, and provides high adhesiveness. The epoxy equivalent of the epoxy resin is preferably 50 or more. The epoxy equivalent is a value measured in accordance with JIS K-7236.

Also, when a pattern is formed using a coating material, resolution may be reduced if the material has high flowability. Therefore, the epoxy compound other than the hydrolyzable silane compound (b) is preferably a compound which is solid at 35° C. or lower. In addition to the materials described above, commercially available negative-type resists such as “SU-8 series” and “KMPR-1000” (trade name) manufactured by MicroChem Corporation; “TMMR S2000” and “TMMF S2000” (trade name) manufactured by TOKYO OHKA KOGYO CO., LTD.; and the like, which are commercially available as negative resists, may also be used as the epoxy compound.

The condensation product is a material that exhibits excellent compatibility with an epoxy compound. Therefore, similar to the photo-polymerization initiator mentioned above, epoxy compounds other than the hydrolyzable silane compound (b) may be added to the coating material or used as a foundation. Even when an epoxy compound other than the hydrolyzable silane compound (b) is used as a foundation, the same effect as that obtained when the epoxy compound is directly added to the liquid-repellent coating material can be obtained due to the compatibility of the coating material with the foundation.

The liquid-repellent coating may be utilized for liquid-repellent coating on a fine pattern in a liquid ejection head.

### Method of Producing Liquid-Repellent Coating

The method for producing a liquid-repellent coating can be used for coating various known materials, but can be applied, for example, to a method for producing a liquid ejection head. The method for producing a liquid-repellent coating can be applied, for example, to a method for producing a liquid ejection head in which the coating material contains a condensation product of a silane mixture, as well as a photopolymerizable resin and a photopolymerization initiator, in addition to a condensation product of a silane mixture. The method for producing the liquid ejection head of this mode is, for example, as follows.

As an example of a method for producing a liquid-repellent coating, the method (A) for producing a liquid ejection head includes the steps of: (1) applying a coating material containing a condensation product of the silane mixture, a photopolymerization initiator, and an epoxy compound other than the hydrolyzable silane compound (b) capable of forming a photopolymerizable resin to a substrate (and optionally drying the coating material) to form a coating film of the coating material; (2) exposing and developing the coating film of the coating material; and (3) after the exposure and development, curing the coating film to form the cured product of the coating material.

In the method (A), the liquid-repellent coating material contains a photo-polymerization initiator and an epoxy compound other than the hydrolyzable silane compound (b). Thus, the liquid-repellent coating obtained by curing the coating material has high liquid-repellency and anti-fouling properties, durability, and smoothness.

The present disclosure also includes a mode in which the liquid ejection head contains a cured product of a photopolymerizable resin containing a photopolymerization initiator. In this case, a cured product of a liquid-repellent coating material is preferably formed on the cured product of the photopolymerizable resin in the liquid ejection head. The method for producing the liquid ejection head of this mode is, for example, as follows.

That is, as an example of a method for producing a liquid-repellent coating, the method (B) for producing a liquid ejection head includes the steps of: (1) applying a photopolymerizable resin mixture containing an epoxy compound other than the hydrolyzable silane compound (b) capable of forming a photopolymerizable resin, and a photopolymerization initiator to a substrate and drying the photopolymerizable resin mixture to form a photopolymerizable resin layer; (2) applying the coating material to the photopolymerizable resin layer to form a coating film of the coating material; (3) simultaneously exposing and developing the photopolymerizable resin layer and the coating film; and (4) after the exposure and development, collectively curing the photopolymerizable resin layer and the coating film.

The step (4) makes it possible to form a cured product of the coating material and a cured product of the photopolymerizable resin. In the production method (B), the photopolymerizable resin layer, which serves as the foundation, contains an epoxy compound other than a hydrolyzable silane compound and a photopolymerization initiator, and a coating film of the coating material formed thereon and the photopolymerizable resin layer are partially compatible with each other. For this reason, similar to the method described above, the method may include the step of removing the unexposed portion to form a fine pattern. Also, if the coating film of the coating material and the photopolymerizable resin layer are partially compatible with each other, there may be no clear interface between the photopolymerizable resin layer and the cured product of the coating material.

A liquid ejection head to which a photopolymerizable resin layer and a coating film of a coating material can be applied is described.

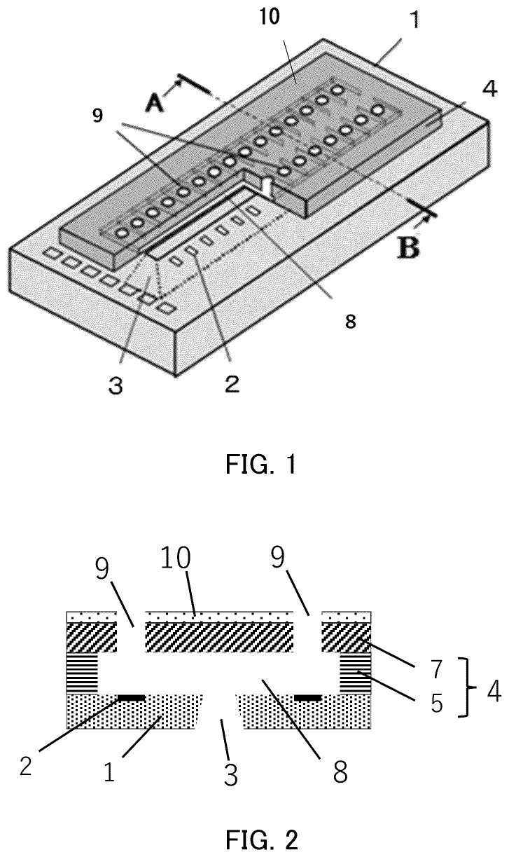

The liquid ejection head is used in a liquid discharge apparatus, such as an inkjet recording apparatus. A configuration example of a liquid ejection head is illustrated in FIG. 1. A cross-sectional view of the liquid ejection head along the line A-B of FIG. 1 is illustrated in FIG. 2.

The liquid ejection head has a photosensitive resin layer 4 that forms an ejection port 9 and a flow path 8, and a substrate 1. The photosensitive resin layer 4, which forms the ejection port 9 and the flow path 8, is provided on the substrate 1. The substrate 1 has a feeding port 3 that supplies liquid to the channel. The surface of the substrate on the side where the flow path 8 and the ejection port 9 are located has an energy-generating element 2. Liquid is supplied from the feeding port 3 to the flow path 8, energized by the energy-generating element 2, and discharged from the ejection port 9 to land on a recording medium, such as a paper sheet.

For example, the ejection port 9 is formed by an ejection port-forming layer 7. The flow path 8 is formed by a flow path-forming layer 5. The photosensitive resin layer 4 includes the ejection port-forming layer 7 and the flow path-forming layer 5. An adhesion-improving layer (not shown) or the like may be present between the ejection port-forming layer 7 and the flow path-forming layer 5.

Regarding the production method (B) described above, the photosensitive resin layer 4 can be the photopolymerizable resin layer described above. The liquid ejection head may then have a cured product 10 of the coating material on the surface where the ejection port 9 are formed, for example, as illustrated in FIGS. 1 and 2. For example, the ejection port-forming layer 7 is a cured product of a photopolymerizable resin, and a cured product 10 of a coating material is formed on the surface of the ejection port-forming layer 7. If the photosensitive resin layer and the coating material are compatible, there may be no clear interface between the photosensitive resin layer 4 and the cured product 10 of the coating material.

In the production method (A) described above, at least one of the ejection port-forming layer 7 and the flow path-forming layer 5, which are the photopolymerizable resin layer, can be a cured product of a coating material. The ejection port-forming layer 7 and the flow path-forming layer 5 may be a cured product of a coating material, and in this case, the entire photosensitive resin layer 4 has good liquid repellency and scratch resistance.

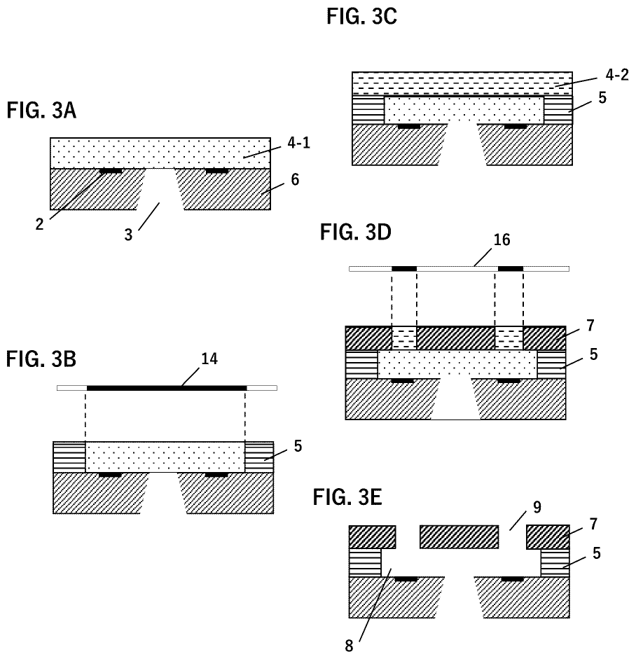

FIGS. 3A to 3E are schematic cross-sectional views illustrating an example of the method (A) for producing the liquid ejection head described above.

First, a photosensitive resin layer 4-1 for forming a flow path-forming layer 5 is formed on a substrate 1 that has an energy-generating element 2 and a feeding port 3 (FIG. 3A). The photosensitive resin layer 4-1 may be a coating material in the production method (A) described above. When an adhesion-improving layer (not illustrated) is formed between an ejection port-forming layer 7 and the flow path-forming layer 5, a material for the adhesion-improving layer may be formed on the photosensitive resin layer 4-1.

Next, the photosensitive resin layer 4-1 is pattern-exposed through a mask 14 having a flow path pattern to form a flow path-forming layer 5 for forming a flow path 8 (FIG. 3B).

Subsequently, a photosensitive resin layer 4-2 is formed on the flow path-forming layer 5 (FIG. 3C). The photosensitive resin layer 4-2 is pattern-exposed through a mask 16 having an ejection port pattern to form an ejection port-forming layer 7 for forming an ejection port 9 (FIG. 3D). Then, the unexposed portion can be removed with an organic solvent or the like, and the coating material and the like can be cured to provide a liquid ejection head (FIG. 3E).

The photosensitive resin layer 4-2 may be a coating material in the production method (A) described above. For example, at least one or both of the photosensitive resin layer 4-1 and the photosensitive resin layer 4-2 are made of the coating material in the production method (A) described above.

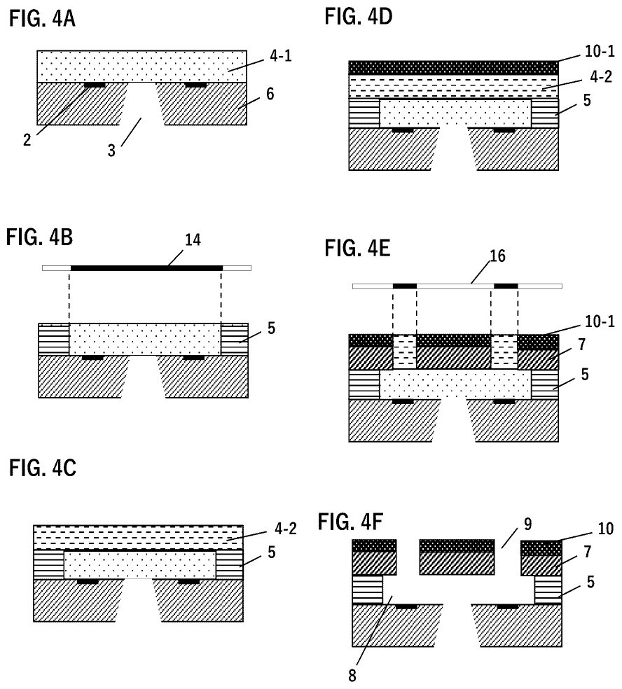

FIGS. 4A to 4F are schematic cross-sectional views illustrating an example of the method (B) for producing the liquid ejection head described above.

First, a photosensitive resin layer 4-1 for forming a flow path-forming layer 5 is formed on a substrate 1 having an energy-generating element 2 and a feeding port 3 (FIG. 4A). The photosensitive resin layer 4-1 may be a photopolymerizable resin layer in the production method (B), a coating material in the production method (A) described above, or a known photosensitive resin layer. When an adhesion-improving layer (not illustrated) is formed between an ejection port-forming layer 7 and a flow path-forming layer 5, a material for the adhesion-improving layer may be formed on the photosensitive resin layer 4-1.

Next, the photosensitive resin layer 4-1 is pattern-exposed through a mask 14 having a flow path pattern to form a flow path-forming layer 5 for forming a flow path 8 (FIG. 4B).

Subsequently, a photosensitive resin layer 4-2 is formed on the flow path-forming layer 5 (FIG. 4C). The photosensitive resin layer 4-2 is a photopolymerizable resin layer in the production method (B) (step (1) in the production method (B)). Then, a coating material is applied to the photosensitive resin layer 4-2 to form a coating film 10-1 of the coating material (FIG. 4D) (step (2) in the production method (B)).

Subsequently, the photosensitive resin layer 4-2 and the coating film 10-1 are simultaneously pattern-exposed through a mask 16 having an ejection port pattern to form an ejection port-forming layer 7 for forming an ejection port 9 (FIG. 4E). Then, the unexposed part is removed with an organic solvent or the like, and the photosensitive resin layer 4-1, the photosensitive resin layer 4-2, and the coating film 10-1 are cured to provide a liquid ejection head (FIG. 4F). By curing the photosensitive resin layer 4-2 and the coating film 10-1, a cured product 10 (liquid-repellent layer 10) of the coating material on the cured product 7 (ejection port-forming layer 7) of the photopolymerizable resin can be obtained.

### EXAMPLES

Examples and Comparative Examples are described below, but the present disclosure is not limited thereto. Various measurements and evaluations were conducted in the manner described below.

### Coating Film Appearance

Development residues and surface states of coating films were observed using a scanning electron microscope (product name: S-4300 manufactured by Hitachi High-Tech Corporation). The appearance of the coating film was evaluated on the basis of the following criteria:

### Development Residues

A: No development residues were observed.
B: Fine development residues of 0.3 μm or less were observed.
C: Development residues more than 0.3 μm were observed.

### Surface State

A: The surface appeared smooth.
B: Fine development residues of 0.3 μm or less were observed.
C: Large unevenness of more than 0.3 μm was observed on the surface.

### Pure Water Contact Angle

As an evaluation of the coating film formed, a dynamic receding contact angle θr with respect to pure water was measured using a micro contact angle meter (product name: DropMeasure manufactured by Microjet Corporation), and initial water repellency was evaluated. Also, as the durability evaluation of the surface of the coating film, the coating film was immersed in an aqueous alkaline solution with a pH of 10 and held at 60° C. for 1 week, then the coating film was washed with water, and then Or to pure water was measured.

Furthermore, to evaluate durability against abrasion (abrasion resistance evaluation), wiping operations were performed 2000 times using a hydrogenated nitrile rubber (HNBR) blade while blowing an aqueous solution containing carbon black onto the coating film, and then Or to pure water was measured. The measured Or was determined with the following criteria.
S: θr was 90° or more
A: θr was 85° or more and less than 90°
B: θr was 80° or more and less than 85°
C: θr was less than 80°

### Example 1

The condensation product was prepared by the methods shown below: 0.1 g (0.05 mol %) of a compound represented by the formula (C1) as component (a), 9.6 g (99.95 mol %) of a compound represented by the formula (C2) as component (b), 8.9 g of propylene glycol monomethyl ether (hereinafter referred to as PGME), 22.2 g of ethanol (hereinafter referred to as EtOH), 0.21 g of aqueous acetate at a concentration of 4200 ppm were stirred in a flask equipped with a cooling tube at room temperature for 5 minutes.

The condensation product was then prepared by heating to reflux for 24 hours. The solution of the condensation product was diluted fourfold with an ethanol/butanol mixed solvent to prepare the water-repellent coating material.

Next, 100 parts by mass of an epoxy compound (trade name: EHPE-3150 manufactured by Daicel Corporation) and 6 parts by mass of a photoacid-generating agent (trade name: SP-172 manufactured by ADEKA Corporation) were dissolved in 80 parts by mass of a solvent of xylene to obtain a photopolymerizable resin composition. The photopolymerizable resin composition was applied to a substrate by spin coating to have a film thickness of 10 μm, and the resulting coating film was heated at 90° C. for 5 minutes to form a photopolymerizable resin layer.

The material for water-repellent coating described above was applied to the photopolymerizable resin layer using a slit coater and heated at 90° C. The coating thickness of the water-repellent coating material was set so that the thickness would be 0.5 μm after finishing the heating. Here, since compatibility with the photopolymerizable resin layer as the foundation occurred, and the interface could not be observed, the film thickness of the coating film of the coating material on the photopolymerizable resin layer could not be measured.

Next, the photopolymerizable resin composition layer and the water-repellent coating material were irradiated with i-rays through a mask having a pattern for evaluation. Thereafter, the heat treatment was performed at 90° C. for 4 minutes. Development was performed with a mixture of methyl isobutylketone (MIBK) and xylene, followed by rinsing with isopropanol to form a desired pattern.

Furthermore, the coating film was heated at 200° C. for 1 hour to cure the coating film to obtain a water-repellent coating. The results are shown in Table 1. The photopolymerizable resin layer provided with a water-repellent coating appeared smooth, and both the initial pure water contact angle and the pure water contact angle after the durability test exhibited high values.

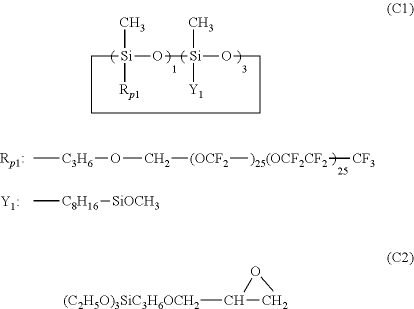

### Example 2

The condensation product was synthesized in the same manner as Example 1, except that the compound (C1) was replaced with a compound of formula (C3) below, and diluted with an ethanol/butanol mixed solvent to prepare the water-repellent coating material. Furthermore, a waterproof coating was obtained in the same procedure as in Example 1. The results are shown in Table 1.

As in Example 1, the surface of the water-repellent coating material appeared smooth, and the initial contact angle exhibited a high value. However, it is considered that the reactivity with the photopolymerizable resin layer as the foundation was low and the pure water contact angle after the durability test was slightly lowered because the component (a) had a smaller number of hydrolyzable silyl groups than in Example 1.

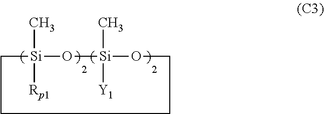

Rₚ₁ and Y₁ are as defined in (C1).

### Example 3

The condensation product was synthesized in the same manner as Example 1, except that the compound (C1) was replaced with a compound of formula (C4) below, and diluted with an ethanol/butanol mixed solvent to prepare the water-repellent coating material. Furthermore, a waterproof coating was obtained in the same procedure as in Example 1. The results are shown in Table 1.

It is considered that the fluorine content of the component (a) was greater than that of the chemical formula (C1), and the fluorine components agglomerate and slight unevenness was observed in the appearance of the coating film. Also, the initial contact angle exhibited a high value. However, it is considered that the reactivity with the photopolymerizable resin layer as the foundation was lower and the pure water contact angle after the durability test was slightly lower than in Example 2 because the component (a) had a smaller number of hydrolyzable silyl groups than (C1) and (C2).

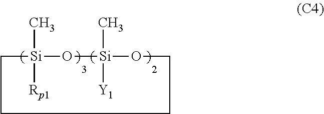

Rₚ₁ and Y₁ are as defined in (C1).

### Example 4

The condensation product was synthesized in the same manner as Example 1, except that the compound (C1) was replaced with a compound of formula (C5) below, and diluted with an ethanol/butanol mixed solvent to prepare the water-repellent coating material. Furthermore, a waterproof coating was obtained in the same procedure as in Example 1. The results are shown in Table 1.

It is considered that the cyclic polyorganosiloxane had a greater number of Si atoms and reduced surface orientation and dispersibility of fluorine compared with Example 1, and all of the coating film appearance, initial contact angle, and contact angle after the durability test were reduced compared with Example 1.

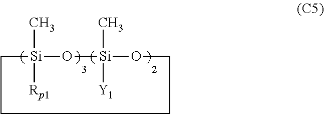

Rₚ₁ and Y₁ are as defined in (C1).

### Example 5

The condensation product was synthesized in the same manner as Example 1, except that the compound (C1) was replaced with a compound of formula (C6) below, and diluted with an ethanol/butanol mixed solvent to prepare the water-repellent coating material. Furthermore, a waterproof coating was obtained in the same procedure as in Example 1. The results are shown in Table 1.

While the coating film appeared smooth, and the initial contact angle exhibited a high value, it was considered that the alkyl group bound to the hydrolyzable silyl group was shorter as compared with Example 1, and therefore, the reactivity with the photopolymerizable resin layer as the foundation was reduced, and the contact angle after the durability test was lowered.

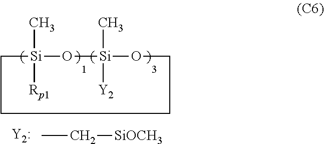

Rₚ₁ is as defined in (C1).

### Example 6

The condensation product was synthesized in the same manner as Example 1, except that the compound (C1) was replaced with a compound of formula (C7) below, and diluted with an ethanol/butanol mixed solvent to prepare the water-repellent coating material. Furthermore, a waterproof coating was obtained in the same procedure as in Example 1. The results are shown in Table 1.

The coating film appeared smooth, and the initial contact angle and the contact angle after the wiping durability test exhibited high values, but it was considered that the contact angle after the ink durability test was reduced because the alkyl group bound to the hydrolyzable silyl group was longer and had higher molecular mobility as compared with Example 1.

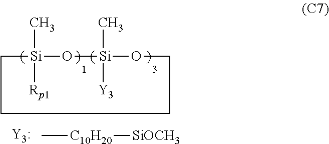

Rₚ₁ is as defined in (C1).

### Examples 7 to 8

In Examples 7 and 8, the amount of component (a) added was changed to the values shown in Table 1. Except for these, the condensation product was synthesized in the same manner as Example 1, and diluted with an ethanol/butanol mixed solvent to prepare the water-repellent coating material. Furthermore, a waterproof coating was obtained in the same procedure as in Example 1.

In Example 7, since the amount of the component (a) added was smaller than in Example 1, the coating film appeared smooth, but the initial contact angle and the contact angle after the durability test were slightly reduced. Conversely, in Example 8, because a larger amount of the component (a) was added, the initial contact angle and the contact angle after the durability test exhibited high values, but the fluorine components agglomerated, and slight unevenness was observed in the appearance of the coating film.

### Examples 9 to 10

In Examples 9 and 10, the condensation product was synthesized as in Example 1, except that the component (b) was changed from the compound (C2) to formulas (C8) and (C9) below, respectively, and diluted with an ethanol/butanol mixed solvent to prepare a water-repellent coating material. Furthermore, a waterproof coating was obtained in the same procedure as in Example 1.

In Example 9, the coating film appeared smooth, and the initial contact angle and the contact angle after the durability test exhibited high values even if the component (b) was changed. In Example 10, the compound was changed to a compound (C9) with a cyclohexyl skeleton. The reactivity with the photosensitive resin layer as the foundation was slightly low, and the contact angle after the wiping durability test was slightly reduced. However, the coating film appeared smooth, and both the initial contact angle and the contact angle after immersion in ink exhibited high values.

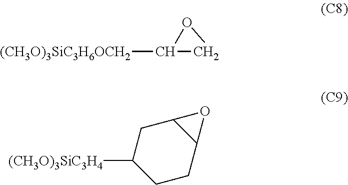

### Examples 11 to 12

In Example 11, 0.4 parts by mass of a photoacid-generating agent (trade name: SP-172 manufactured by ADEKA Corporation) was added to 100 parts by mass of the water-repellent coating material prepared in Example 1 to prepare the water-repellent coating material.

The water-repellent coating material was applied to a substrate by a spin coating method, and treated at 90° C. to prepare a coating film with a thickness of 0.5 μm. The results are shown in Table 1. Similarly to Example 1, the coating film appeared smooth, and both the initial contact angle and the contact angle after the durability test exhibited high values.

In Example 12, 0.8 parts by mass of a photo acid-generating agent (trade name: SP-172 manufactured by ADEKA Corporation) and 7 parts by mass of an epoxy compound (trade name: EHPE-3150 manufactured by Daicel Corporation) were added to 100 parts by mass of the water-repellent coating material prepared in Example 1 to prepare a water-repellent coating material.

The water-repellent coating material was applied to a substrate by a spin coating method, and treated at 90° C. to prepare a coating film with a thickness of 0.5 μm. The results are shown in Table 1. Similarly to Example 1, the coating film appeared smooth, and both the initial contact angle and the contact angle after the durability test exhibited high values.

### Examples 13 to 20

In Examples 13 to 20, 0.1 g (0.05 mol %) of the compound represented by the formula (C1) mentioned above as the component (a), 12.99 g (49.98 mol %) of the compound represented by the formula (C2) mentioned above as the component (b), 49.97 mol % of the component (C) listed in Table 1, 8.9 g of propylene glycol monomethyl ether (hereinafter referred to as PGME), 22.2 g of ethanol (hereinafter referred to as EtOH), 0.21 g of an acetic acid aqueous solution at a concentration of 4200 ppm were stirred at room temperature for 5 minutes in a flask equipped with a cooling tube. After that, the condensation product was prepared by heating to reflux for 24 hours.

The solution of the condensation product was diluted fourfold with an ethanol/butanol mixed solvent to prepare the water-repellent coating material. Furthermore, a waterproof coating was obtained in the same procedure as in Example 1. The results are shown in Table 1.

Compared with Example 1, the components (c) of the formulas (C10) to (C17) below were added to Examples 13 to 20. As a result, similarly to Example 1, the coating film appeared smooth, and both the initial contact angle and the contact angle after the durability test exhibited high values.
3,3,3-trifluoropropyltrimethoxysilane (C10);
trimethoxy (1H,1H,2H,2H-nonafluorohexyl) silane (C11);
trimethoxy-1H,1H,2H,2H-tridecafluoro-n-octylsilane (C12);
trimethoxy (pentafluorophenyl) silane (C13);
3,3,3-trifluoropropyltriethoxysilane (C14);
triethoxy (1H,1H,2H,2H-nonafluorohexyl) silane (C15);
triethoxy-1H,1H,2H,2H-tridecafluoro-n-octylsilane (C16); and
triethoxy (pentafluorophenyl) silane (C17).

### Comparative Example 1

The condensation product was synthesized in the same manner as Example 1, except that the component (a) was changed from the (C1) to the formula (C18) below, and diluted with an ethanol/butanol mixed solvent to prepare the water-repellent coating material. Furthermore, a waterproof coating was obtained in the same procedure as in Example 1. Note that in Comparative Example 1, Novec HFE 7200 (hydrofluoroether manufactured by 3M Company) was used instead of PGME. The results are shown in Table 1.

The compound (C18) had a significantly lowered contact angle after the durability test to 30° or less (non-measurable level) because it had no cyclic polyorganosiloxane and a short polyfluoropolyether group.

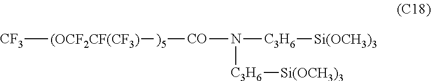

### Comparative Example 2

The condensation product was synthesized in the same manner as Example 1, except that the component (a) was changed from the (C1) to the formula (C19) below, and diluted with an ethanol/butanol mixed solvent to prepare the water-repellent coating material. Furthermore, a waterproof coating was obtained in the same procedure as in Example 1. The results are shown in Table 1.

The compound (C19) had a long-chain polyfluoropolyether group, but did not have a cyclic polyorganosiloxane. Therefore, fluorine orientation to the surface was reduced, and the initial contact angle and the contact angle after the durability test were significantly reduced to 30° or less (non-measurable levels).

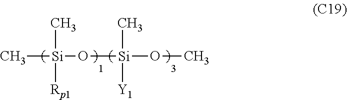

Rₚ₁ and Y₁ are as defined in (C1).

### Comparative Example 3

The condensation product was synthesized in the same manner as Example 1, except that the component (a) was changed from the (C1) to the formula (C20) below, and diluted with an ethanol/butanol mixed solvent to prepare the water-repellent coating material. Furthermore, a waterproof coating was obtained in the same procedure as in Example 1. The results are shown in Table 1.

The compound (C20) had a cyclic polyorganosiloxane, but had a short polyfluoropolyether group and a low sliding property. Therefore, the contact angle after the durability test was significantly reduced to 30° or less (non-measurable level).

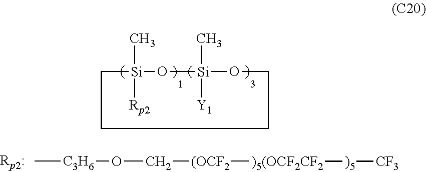

Y₁ is as defined in (C1).

### Comparative Example 4

The condensation product was synthesized in the same manner as Example 1, except that the component (a) was changed from the (C1) to the formula (C21) below, and diluted with an ethanol/butanol mixed solvent to prepare the water-repellent coating material. Furthermore, a waterproof coating was obtained in the same procedure as in Example 1. The results are shown in Table 1.

The compound (C21) had a cyclic polyorganosiloxane, but the perfluoropolyether group has a longer chain than that in Example 1, and therefore, exhibited excellent sliding properties. However, fluorine is less likely to be oriented to the surface, and the dispersibility of the fluorine component is also reduced. As a result, unevenness was observed in the appearance of the coating film, and both the initial contact angle and the contact angle after the durability test exhibited as low values as 30° or less (non-measurable level).

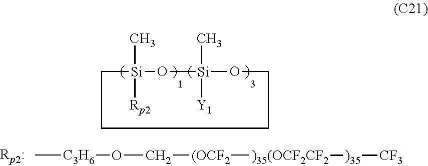

Y₁ is as defined in (C1).

TABLE 1

| | Condensation product | | | | | Additive | |
|---|---|---|---|---|---|---|---|
| | Hydrolyzable silane compound | | | | | Photoacid- | |
| | (mol %, molar ratio) | | | Solvent | | generating | Resin |
| Example | Component | Component | Component | (mass %) | | agent (parts | (parts by |
| No. | (a) | (b) | (c) | PGME | EtOH | by mass) | mass) |
| 1 | (C1) | (C2) | — | 20 | 80 | 0 | 0 |
| | 0.05 | 99.95 | 0 | | | | |
| 2 | (C3) | (C2) | — | 20 | 80 | 0 | 0 |
| | 0.05 | 99.95 | 0 | | | | |
| 3 | (C4) | (C2) | — | 20 | 80 | 0 | 0 |
| | 0.05 | 99.95 | 0 | | | | |
| 4 | (C5) | (C2) | — | 20 | 80 | 0 | 0 |
| | 0.05 | 99.95 | 0 | | | | |
| 5 | (C6) | (C2) | — | 20 | 80 | 0 | 0 |
| | 0.05 | 99.95 | 0 | | | | |
| 6 | (C7) | (C2) | — | 20 | 80 | 0 | 0 |
| | 0.05 | 99.95 | 0 | | | | |
| 7 | (C1) | (C2) | — | 20 | 80 | 0 | 0 |
| | 0.005 | 99.995 | 0 | | | | |
| 8 | (C1) | (C2) | — | 20 | 80 | 0 | 0 |
| | 0.9 | 99.1 | 0 | | | | |
| 9 | (C1) | (C8) | — | 20 | 80 | 0 | 0 |
| | 0.05 | 99.95 | 0 | | | | |
| 10 | (C1) | (C9) | — | 20 | 80 | 0 | 0 |
| | 0.05 | 99.95 | 0 | | | | |
| 11 | (C1) | (C2) | — | 20 | 80 | 0.4 | 0 |
| | 0.05 | 99.95 | 0 | | | | |
| 12 | (C1) | (C2) | — | 20 | 80 | 0.8 | 7 |
| | 0.05 | 99.95 | 0 | | | | |
| 13 | (C1) | (C2) | (C10) | 20 | 80 | 0 | 0 |
| | 0.05 | 49.98 | 49.97 | | | | |
| 14 | (C1) | (C2) | (C11) | 20 | 80 | 0 | 0 |
| | 0.05 | 49.98 | 49.97 | | | | |
| 15 | (C1) | (C2) | (C12) | 20 | 80 | 0 | 0 |
| | 0.05 | 49.98 | 49.97 | | | | |
| 16 | (C1) | (C2) | (C13) | 20 | 80 | 0 | 0 |
| | 0.05 | 49.98 | 49.97 | | | | |
| 17 | (C1) | (C2) | (C14) | 20 | 80 | 0 | 0 |
| | 0.05 | 49.98 | 49.97 | | | | |
| 18 | (C1) | (C2) | (C15) | 20 | 80 | 0 | 0 |
| | 0.05 | 49.98 | 49.97 | | | | |
| 19 | (C1) | (C2) | (C16) | 20 | 80 | 0 | 0 |
| | 0.05 | 49.98 | 49.97 | | | | |
| 20 | (C1) | (C2) | (C17) | 20 | 80 | 0 | 0 |
| | 0.05 | 49.98 | 49.97 | | | | |
| Comparative 1 | (C18) | (C2) | — | 20 | 80 | 0 | 0 |
| | 0.05 | 99.95 | 0 | HFE 7200 | | | |
| Comparative 2 | (C19) | (C2) | — | 20 | 80 | 0 | 0 |
| | 0.05 | 99.95 | 0 | | | | |
| Comparative 3 | (C20) | (C2) | — | 20 | 80 | 0 | 0 |
| | 0.05 | 99.95 | 0 | | | | |
| Comparative 4 | (C21) | (C2) | — | 20 | 80 | 0 | 0 |
| | 0.05 | 99.95 | 0 | | | | |

Pure water contact angle

| | | After |
|---|---|---|
| Appearance of coating film | After | wiping |

| Example | Development | Surface | | immersion | durability |
|---|---|---|---|---|---|
| No. | residues | state | Initial | in ink | test |
| 1 | A | A | S | S | S |
| 2 | A | A | S | A | A |
| 3 | A | B | A | B | B |
| 4 | B | B | B | B | B |
| 5 | A | A | A | B | B |
| 6 | A | A | A | B | B |
| 7 | A | A | B | B | B |
| 8 | B | B | A | A | B |
| 9 | A | A | S | S | S |
| 10 | A | A | S | S | A |
| 11 | A | A | S | S | S |
| 12 | A | A | S | S | S |
| 13 | A | A | S | S | S |
| 14 | A | A | S | S | S |
| 15 | A | A | S | S | S |
| 16 | A | A | S | S | S |
| 17 | A | A | S | S | S |
| 18 | A | A | S | S | S |
| 19 | A | A | S | S | S |
| 20 | A | A | S | S | S |
| Comparative 1 | A | A | S | C | C |
| Comparative 2 | B | B | C | C | C |
| Comparative 3 | A | A | A | C | C |
| Comparative 4 | B | B | C | C | C |

In the table, the component (a) represents a hydrolyzable silane compound (a) represented by formula (1), the component (b) represents a hydrolyzable silane compound (b) having an epoxy group, the component (c) represents another hydrolyzable silane compound (c) different from the component (a) and the component (b).

In Examples 1 to 10 and 13 to 20 and Comparative Examples 1 to 4, a coating material was applied to the photopolymerizable resin layer on the substrate. In Examples 11 and 12, a coating material was applied to a substrate.

According to the present disclosure, a liquid ejection head that exhibits excellent ink resistance and scratch resistance, and a method for producing the liquid ejection head can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174442, filed October 3. 2024, which is hereby incorporated by reference herein in its entirety.

What is claimed is:

1. A liquid ejection head comprising a cured product of a liquid-repellent coating material,
the coating material comprising:
a condensation product of a silane mixture comprising
a hydrolyzable silane compound (a) having a perfluoropolyether group and a cyclic polyorganosiloxane group and represented by formula (1) below and
a hydrolyzable silane compound (b) having an epoxy group; 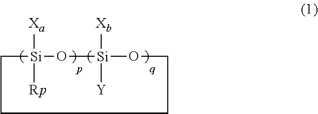
in the formula (1), p is an integer of 1 or more, q is an integer of 1 or more, p+q is 4 or more, and an arrangement of a structure of a parenthesis with p and a structure of a parenthesis with q may be block or random;
Xas represent alkyl groups;
Xbs represent alkyl groups;
Rps are perfluoropolyether groups represented by formula (2) below;
Ys are structures having hydrolyzable silyl groups represented by formula (3) below; 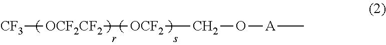
in the formula (2), r is 20 to 30, and s is 20 to 30; an arrangement of a structure of a parenthesis with r and a structure of a parenthesis with s may be block or random;
and A represents an organic group; 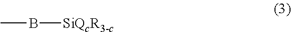
in the formula (3), c is an integer of 3 or less, B is a C1-12 organic group, Qs are hydrolyzable substituents, and R₅ are non-hydrolyzable substituents.

2. The liquid ejection head according to claim 1, wherein the hydrolyzable silane compound (b) having the epoxy group is a compound represented by formula (9) below: 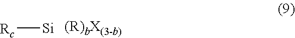
in the formula (9), Rc is a non-hydrolyzable substituent having an epoxy group and represented by -E-Z, wherein Z is an epoxy group, a glycidyl group, a glycidoxy group, or an epoxycycloalkyl group, and E is a C1-8 alkylene group;
Rs are non-hydrolyzable substituents and each independently a C1-3 alkyl group or a phenyl group; Xs are halogen atoms, C1-6 alkoxy groups, hydroxy groups, amino groups, or hydrogen atoms; and b is an integer from 0 to 2.

3. The liquid ejection head according to claim 1, wherein the p is 1 to 5, the q is 1 to 5, and the p+q is 4 to 10;
the Xas are C1-3 alkyl groups, the Xbs are C1-3 alkyl groups;
the A is a C1-6 alkylene group;
the c is 2 or 3;
the B is a C1-12 alkylene group;
the Qs are each independently a halogen atom, a C1-6 alkoxy group, a hydroxy group, an amino group, or a hydrogen atom; and
the Rs are C1-3 alkyl groups or phenyl groups.

4. The liquid ejection head according to claim 1, wherein the p is 1 and the q is 3 in the formula (1).

5. The liquid ejection head according to claim 1, wherein the A in the formula (2) is —C₃H₆—.

6. The liquid ejection head according to claim 1, wherein r=s=25 in the formula (2).

7. The liquid ejection head according to claim 1, wherein the Y has a structure represented by formula (6) below.

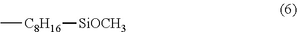

8. The liquid ejection head according to claim 1, wherein in the hydrolyzable silane compound comprised in the silane mixture, the hydrolyzable silane compound (a) has a content ratio of 0.01 to 0.80 mol %.

9. The liquid ejection head according to claim 1, wherein the hydrolyzable silane compound (b) having an epoxy group is at least one selected from the group consisting of a compound represented by formula (7) below and a compound represented by formula (8) below.

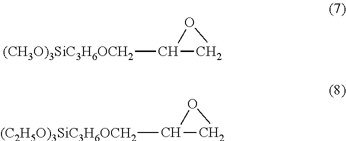

10. The liquid ejection head according to claim 1, wherein
the liquid ejection head comprises a cured product of a photopolymerizable resin comprising a photopolymerization initiator, and
the cured product of the liquid-repellent coating material is formed on the cured product of the photopolymerizable resin.

11. The liquid ejection head according to claim 1, wherein the coating material further comprises a photopolymerizable resin and a photopolymerization initiator.

12. A method for producing a liquid ejection head, wherein
the liquid ejection head comprising a cured product of a liquid-repellent coating material,
the coating material comprising:
a condensation product of a silane mixture comprising
a hydrolyzable silane compound (a) having a perfluoropolyether group and a cyclic polyorganosiloxane group and represented by formula (1) below and
a hydrolyzable silane compound (b) having an epoxy group, wherein
the liquid ejection head comprises a cured product of a photopolymerizable resin comprising a photopolymerization initiator, and
the cured product of the liquid-repellent coating material is formed on the cured product of the photopolymerizable resin, wherein
the method comprising:
(1) applying a photopolymerizable resin mixture comprising an epoxy compound other than the hydrolyzable silane compound (b) capable of forming the photopolymerizable resin and the photopolymerization initiator to a substrate and drying the photopolymerizable resin mixture to form a photopolymerizable resin layer;
(2) applying the coating material to the photopolymerizable resin layer to form a coating film of the coating material;
(3) simultaneously exposing and developing the photopolymerizable resin layer and the coating film; and
(4) after the exposure and the development, collectively curing the photopolymerizable resin layer and the coating film; 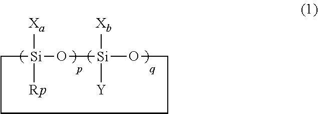
in the formula (1), p is an integer of 1 or more, q is an integer of 1 or more, p+q is 4 or more, and an arrangement of a structure of a parenthesis with p and a structure of a parenthesis with q may be block or random;
Xas represent alkyl groups;
Xbs represent alkyl groups;
Rps are perfluoropolyether groups represented by formula (2) below;
Ys are structures having hydrolyzable silyl groups represented by formula (3) below; 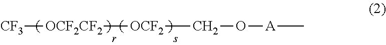
in the formula (2), r is 20 to 30, and s is 20 to 30; an arrangement of a structure of a parenthesis with r and a structure of a parenthesis with s may be block or random; and A represents an organic group; 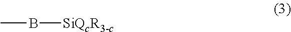
in the formula (3), c is an integer of 3 or less, B is a C1-12 organic group, Qs are hydrolyzable substituents, and R₅ are non-hydrolyzable substituents.

13. A method for producing a liquid ejection head, wherein
the liquid ejection head comprising a cured product of a liquid-repellent coating material,
the coating material comprising:
a condensation product of a silane mixture comprising
a hydrolyzable silane compound (a) having a perfluoropolyether group and a cyclic polyorganosiloxane group and represented by formula (1) below and
a hydrolyzable silane compound (b) having an epoxy group, wherein
the coating material further comprises a photopolymerizable resin and a photopolymerization initiator, wherein
the method comprising:
(1) applying the coating material comprising
the condensation product of the silane mixture,
the photopolymerization initiator, and
an epoxy compound other than the hydrolyzable silane compound (b) capable of forming the photopolymerizable resin
to a substrate to form a coating film of the coating material;
(2) exposing and developing the coating film of the coating material; and
(3) after the exposure and the development, curing the coating film to form the cured product of the coating material; 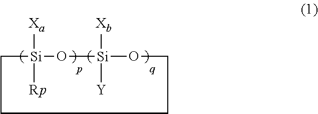
in the formula (1), p is an integer of 1 or more, q is an integer of 1 or more, p+q is 4 or more, and an arrangement of a structure of a parenthesis with p and a structure of a parenthesis with q may be block or random;
Xas represent alkyl groups;
Xbs represent alkyl groups;
Rps are perfluoropolyether groups represented by formula (2) below;
Ys are structures having hydrolyzable silyl groups represented by formula (3) below; 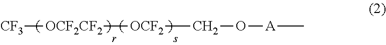
in the formula (2), r is 20 to 30, and s is 20 to 30; an arrangement of a structure of a parenthesis with r and a structure of a parenthesis with s may be block or random; and A represents an organic group; 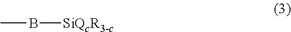
in the formula (3), c is an integer of 3 or less, B is a C1-12 organic group, Qs are hydrolyzable substituents, and R₅ are non-hydrolyzable substituents.
